(19) United States
(12) Patent Application Publication
(10) Pub. No.: US 2026/0298459 A1
(43) Pub. Date: Oct. 1, 2026

(54) Illumination Apparatus for the Cover of a Sewage or Sump Pump Basin

(71) Applicants: Craig Nowicki, South Bend, IN (US); Corey Christian Parsons, Edwardsburg, MI (US)

(72) Inventors: Craig Nowicki, South Bend, IN (US); Corey Christian Parsons, Edwardsburg, MI (US)

(21) Appl. No.: 18/831,774

(22) Filed: Aug. 25, 2025

Related U.S. Application Data
(63) Continuation of application No. 18/831,530, filed on Mar. 31, 2025, now abandoned.

(51) Int. Cl. F21V 31/00; E03F 7/12; F21Y 115/10

(52) U.S. Cl. CPC F21V 31/005; E03F 7/12; F21Y 2115/10

(57) ABSTRACT

A removable and repositionable attachment to a sewage/sump basin cover is provided, which releasably receives and retains a self-contained illumination device to provide illumination through the cover and into the basin interior, and provides illumination exteriorly of the basin to identify the location of the self-contained illumination device via a peripheral ring of illumination when the device is actuated. The attachment can be sealingly mounted in conventionally sized apertures in the cover, including apertures otherwise used for fluid conduits leading to and from the basin.

### BACKGROUND OF THE INVENTION

The present patent application is a continuation patent application of U.S. patent application Ser. No. 18/831,530, filed on Mar. 31, 2025, having the same title as the present patent application; and the present patent application claims the priority benefits of that prior patent application under 35 U.S.C. § 120.

The present invention relates generally to sewage and sump pump basins, and, more particularly, to apparatus for incorporation with the covers for such basins.

In general, residential and light commercial sewage and sump pump systems include a basin which in mounted into the basement or lowest floor of the building, and extend downwardly below the lowest floor level. These basins collect drain water and/or excess or waste fluid therein. One or more pumps are typically mounted in each of the basins, and the pumps are actuated by the presence of a predetermined level of fluid in the basin to force that fluid out of the basin and away from the building. Various sensors, electrical or mechanical, can be used to actuate the pumps for that purpose. The pumps are typically electrically powered. The pumps are usually covered, and the covers may be sealed against fluid and/or air egress from the basin. The basins and/or the covers may have one or more apertures therein to accommodate inlet and outlet pipes and the electrical power connection(s) to the pump and its sensors. These pipes and power connections are typically sealed with respect to the apertures they are using in the cover. The covers are typically at floor level.

Occasionally, it is necessary to inspect the interior of such basins to determine if the system is functioning properly, and/or to service and/or replace the pumps, sensors, and the like. For that purpose, prior covers have typically included a transparent portion which allowed for visual inspection of the basin interior without removal of the cover and/or breaking the cover/basin seal. However, such basins are not always mounted in areas of the building with the best illumination. Also, fluid pipes running into and out of the cover can interfere with the amount of available building-based illumination passing through the transparent portion of the cover. Further, placement of the basins on the floor often results in dirt and debris clouding or staining that transparency. Accordingly, supplemental illumination is often needed in order to see the basin interior.

Previously, it has been suggested to specially mount LED illumination on the cover underside, within the sealed portion of the basin, and provide electrical power from additional wires passing through or around the cover to an electrical power supply within the building. While such LEDs may have the structural integrity to function well in such an adverse fluid dynamic and vibration prone environment, every additional electrical power line needed for the basin system can be problematic and unduly expensive. Also, additional components on the basin interior increase the potential for additional servicing requirements. Further, every time additional sealing is needed for the basin cover, each service event can take more time and expense in resealing the cover apertures. In addition, these prior in-basin illumination arrangements may still require supplemental illumination to inspect portions of the basin system not locating within the basin interior.

Previously, it has also been suggested to put a cell phone flashlight adjacent the transparent portion of the cover, so as to illuminate the basin interior. Unfortunately, the accumulation of dirt, debris, and extraneous fluid against the top surface of the cover, due to its placement in the floor, can lead to unsanitary or otherwise undesirable conditions being applied to the cell phone. Separate flashlights can be similarly used, even though they are significantly less ubiquitous these days than previously, but they would still be prone to contact with floor debris, etc., and require extra cleaning after the inspection.

Further, in the event that the cover had to be opened for servicing, these portable illumination sources have been prone to undesirable movement relative to the cover and/or basin during the servicing work, since they are not configured to adhere to the cover or basin at a particular location and provide the work light needed during servicing. In addition, when the basin system does need to be serviced, there is often limited space within which that work can be performed. Using a separate cell phone or flashlight in that work space can take up a significant portion of the available space, especially as components are moved around during the process.

### OBJECTIVES OF THE INVENTION

Accordingly, a primary objective of the present invention is to provide improved sewage and sump basin systems, particularly for use in confined spaces. These improvements include providing basin cover arrangements which:
a. have lower overall costs of manufacture, installation, and maintenance,
b. increase the ease and economy of use and/or operation,
c. facilitate inspection of the interior portions of the basin, and
d. accommodate a variety of different uses.

### SUMMARY OF THE INVENTION

These and other objectives of the present invention are achieved by the provision of a removable and repositionable attachment to a sewage/sump basin cover, which releasably receives and retains a self-contained illumination device to provide illumination through the cover and into the basin interior, and provides illumination exteriorly of the basin to identify the location of the self-contained illumination device via a peripheral ring of illumination when the device is actuated. The attachment can be sealingly mounted in conventionally sized apertures in the cover, including apertures otherwise used for fluid conduits leading to and from the basin.

Other objects, advantages, and novel features of the present invention will become readily apparent from the following drawings and detailed description of certain preferred and alternative embodiments.

### BRIEF DESCRIPTION OF THE DRAWINGS

FIG. 1 shows a side view of a sewage or sump basin system incorporating the present invention therein (the background indicia and environment forming no portion of that system), but with the self-contained illumination device not actuated.

FIG. 2 shows a top, front perspective view of the basin system of FIG. 1.

FIG. 3 shows a partial top view of the basin system of FIG. 1 with the attachment of the present invention removed from a cover aperture and placed on the surface of the cover.

FIG. 4 shows a partial top view of the basin system of FIG. 1 with the attachment of the present invention removed from the cover aperture and placed on the surface of the cover and the self-contained illumination device removed from the attachment and also placed upside down on the surface of the cover.

FIG. 5 shows an enlarged, partial top view of the basin system of FIG. 1 with the attachment of the present invention removed from the cover aperture and placed on the surface of the cover and the self-contained illumination device removed from the attachment and also placed sideways on the surface of the cover.

FIG. 6 shows an enlarged, partial top view of the basin system of FIG. 1 with the attachment of the present invention removed from the cover aperture and placed sideways on the cover with the self-contained illumination device removed from the attachment.

FIG. 7 shows an enlarged, partial top view of the basin system of FIG. 1 with the self-contained illumination device actuated.

FIG. 8 shows a schematic line drawing side view of the attachment of the present invention.

FIG. 9 shows a schematic line cross-sectional drawing top view of an alternative embodiment of the attachment of the present invention, as taken along line 9-9 of FIG. 8. FIG. 10 shows a schematic line drawing top view of the attachment of the present invention of the embodiment of FIG. 8.

FIG. 11 shows a schematic line drawing top perspective view of the attachment of the present invention of the embodiment of FIG. 8.

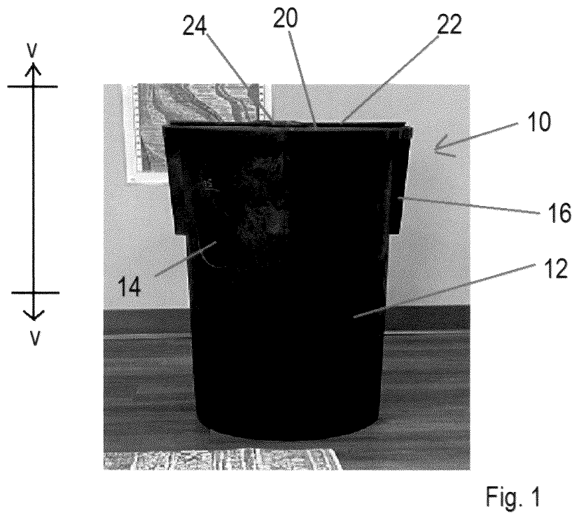

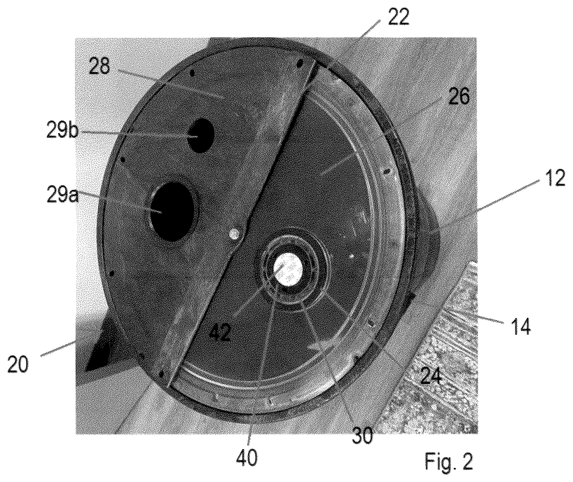

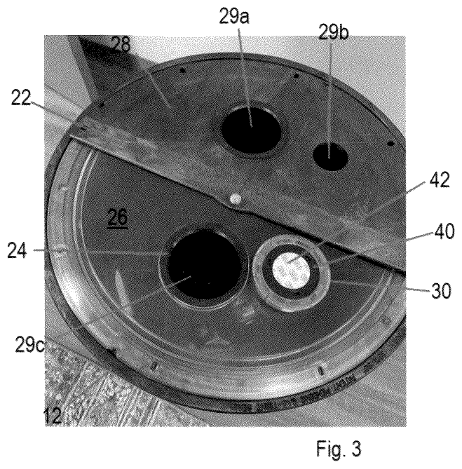

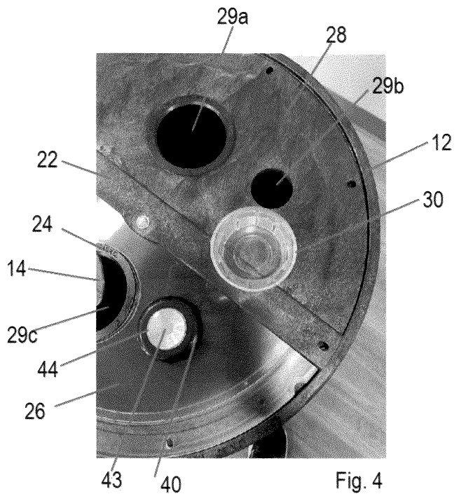

### DETAILED DESCRIPTION OF PREFERRED EMBODIMENTS:

The figures show schematically, and in best mode versions, embodiments of the present invention, both generically and specifically. The drawings are not precisely to scale from one to the next.

The following numbered features are illustrated in the drawings:
the sewage or sump basin system 10 having a vertical elevation along line V-V, including:
   a basin 12 having an aperture 14 therein for receiving a fluid inlet pipe or conduit and allowing fluid ingress to the basin interior, and which may include a plurality of vertically extending reinforcing ribs 16 about its exterior surface,
   a cover 20, which may be removably sealed in a conventional manner
   to the top of basin 12, including:
      a transparent portion 26,
      an opaque portion 28,
      a connecting rib 22 on portion 28 to overlap portion 26 and sealingly join portions 26 and 28,
      a plurality of apertures 29a, 29b, 29c passing through cover 20 and sized to allow access to the interior of basin 12 for fluid and/or electrical conduits and/or manual access to pumps, sensors, related equipment, and fluid within basin 12,
      sealing ring 24 within aperture 29c,
   attachment 30, removably inserted into sealing ring 24 and aperture 29c and provided with a fluid seal against cover 20 by sealing ring 24, having:
      an outer peripheral surface 31,
      a bottom, transparent fluid cover or wall 32,
      an inner peripheral surface 33 spaced apart from surface 31,
      radially extending web elements 34 joining surfaces 31 and 33, preferably formed from transparent material,
      peripheral cavities 35 spaced about the attachment and separating surfaces 31 and 33 and web elements 34,
      translucent surfaces 36, spaced apart by web elements 34, and located on surfaces 31 and/or 33,
      ledge or lip 38 extending radially outward from surface 31 and dimensioned to be engagable with the upper surface of sealing ring 24 when attachment 30 is inserted into sealing ring 24 so as to retain attachment 30 to cover 20 but without appreciable elevation of attachment 30 along line V-V above sealing ring 24 and preferably below the elevation of rib 22 along line V-V, and
   self-contained illumination device 40, having:
      an actuating button 42,
      an illumination source 43, and
      a transparent lens cover 44 which projects outwardly from the housing of device 40 in the direction of illumination from source 43.

These features are usable in the following manner. Cover 20 permits access to basin 12 either by removing the conduits from apertures 29a-c and/or by removing portion 28 from portion 26. Visual inspection of the interior of basin 12 is accomplished by having at least a portion of cover 20 formed from transparent material. Cover 20 may, in some embodiments of the present invention, be formed entirely from transparent material. Cover 20 can also, in some embodiments of the present invention, be formed from a single, unitary element (omitting use of a separate portion 28 and connecting rib 22).

Attachment 30 preferably is formed to fit within a conventionally sized fluid conduit aperture and use a sealing ring 24 which is conventionally used with fluid conduits passing through cover 20. Attachment 30 is preferably generally cylindrical, but in other embodiments attachment 30 can be formed with a polygonal circumference or peripheral shape for outer surface 31. In especially preferred embodiments of the present invention, a plurality of similarly sized apertures are used in cover 20, and attachment 30 can be repositioned as needed between those apertures when the basin system is being serviced. Alternatively, when aperture 29c, used for retaining attachment 30, is needed for access to the interior of basin 12, attachment 30 (and/or device 40) can be readily removed and placed onto the transparent portion 26 of cover 20 to continue to provide illumination to the interior of basin 12 or, alternatively, to provide illumination in any other needed direction for the service incident. Inner surface 33 is preferably formed to closely fit the exterior peripheral configuration of self-contained illumination device 40.

Device 40 may, for example, be a conventional battery powered LED based light source. Preferably, device 40 is selected to be relatively flat or puck-like in its exterior configuration, having the actuating button on one side and sufficient large as to permit easy use by a gloved hand. Preferably, the light source side of the device would be on the opposite side as the actuating button, thus directing illumination downward, into the basis interior when device 40 is mounted into attachment 30 and used with the present invention.

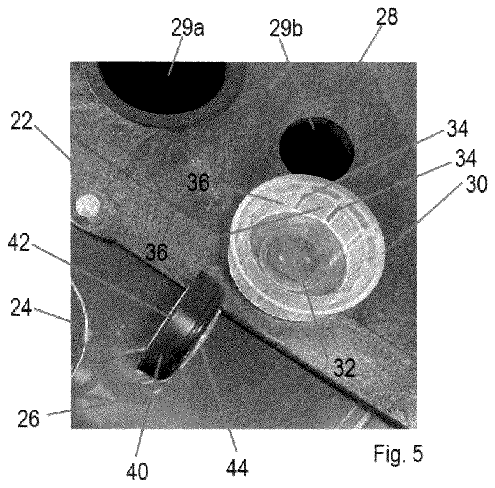

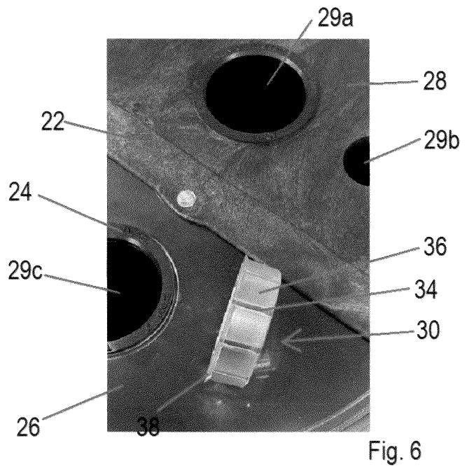

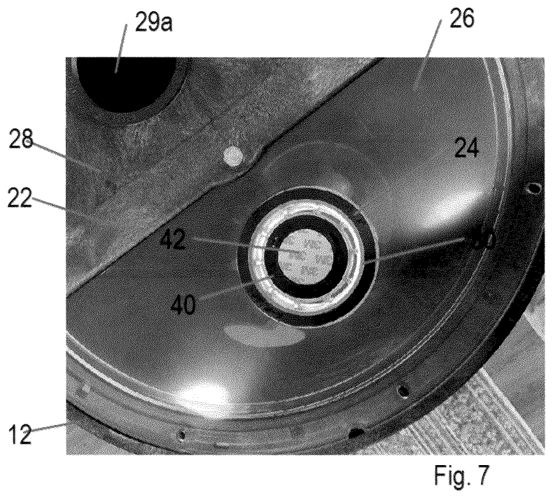

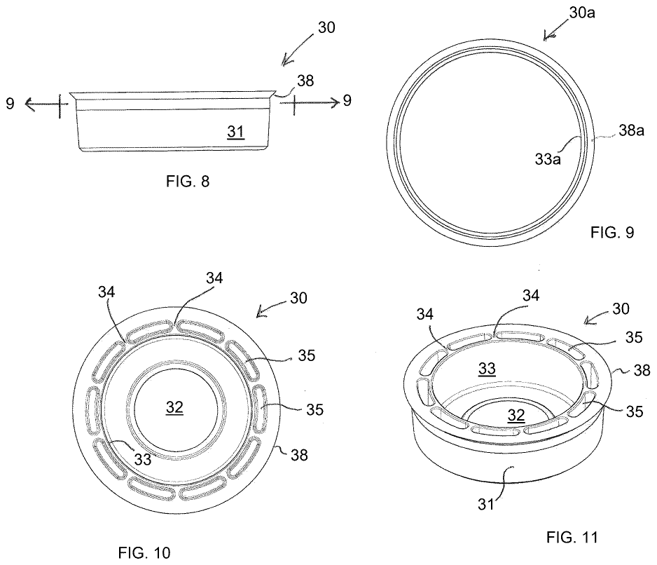

In preferred embodiments, lens cover 44 will transmit a portion of the illumination sideways, rather than downward, and into the material used for attachment 30. This can be accomplished at least in part by having bottom wall 32 formed to be adjacent to lens cover 44 when device 40 is received within attachment 30, and closely conforming bottom wall 32 to the exterior shape of lens cover 44, including its outward projection from the housing of device 40, as that projection is shown in FIG. 5. Further, spacing surfaces 31 and 33 apart and using alternate transparent and translucent surface portions therein provides a readily noticeable illumination pattern about the periphery of device 40 when it is mounted within attachment 30 and attachment 30 is mounted within cover 20, as shown in FIG. 7. This illumination is largely in the opposite or backward direction as the primary illumination by device 40 of the interior of basin 12. This backward illumination is also aesthetically attractive and readily noticed by the user, further serving to increase the ease of locating button 42. Thus, in addition to any aid which cavities 35 may provide in a molding process for creating attachment 30, those cavities can aid in utilization device 40 and attractiveness of the basin cover arrangement.

In this way, the present invention provides a structure or means for illuminating the location of device 40 when it is mounted into cover 20 at a particular location and after it has been actuated. This structure is found, for example, in the illumination array of spaced apart surfaces of attachment 30, which are materially connected by transparent and/or translucent material to the fluid cover, which is itself adjacent and largely conforming to the lens cover of device 40.

Although the present invention has been shown and described herein with respect to certain preferred embodiments and alternative configurations, those were by way of illustration and example only. For example, in certain embodiments, rather than using a transparent portion of cover 20 to provide visualization of the interior of basin 12, video sensing apparatus can be placed into basin 12 or mounted through cover 12, with illumination therefor by attachment 30 and device 40. Further, the alternation of translucent and transparent services in attachment 30 can be on surfaces 31 and/or 33 or, alternatively, in the surface(s) of cavities 35, according to the aesthetic pattern desired for the backward illumination. Also, in certain embodiments, surfaces 31 and 33 do not need to be spaced apart, as shown in the embodiment of FIG. 9.

Accordingly, the spirit and scope of the present invention are limited only by the terms of the following claims:

What is claimed is:

1. An apparatus for the cover of a sump or sewage pump basin, that cover including a means through which the interior of the basin can be visually inspected, the apparatus comprising:
a first portion for receiving and retaining a self-contained illumination device, and
a second portion for securing the self-contained illumination device to a particular location with respect to the cover and for allowing the self-contained illumination device to provide illumination to the interior of the basin from that location.

2. The apparatus according to claim 1 wherein the apparatus is formed to be mountable into an aperture passing through the cover, and the apparatus is sealed against fluid egress from the basin.

3. The apparatus according to claim 2 wherein the apparatus is removably mountable into one or more apertures in the cover which are alternatively used for other sump or sewage basin purposes.

4. The apparatus according to claim 2 wherein the apparatus is mounted into the cover without extending above the vertical elevation of the cover.

5. The apparatus according to claim 1 wherein the first portion removably receives the self-contained illumination device.

6. The apparatus according to claim 1 wherein the self-contained illumination device directs illumination in a first direction and the apparatus redirects a portion of that illumination to another direction so as to identify the location of the self-contained illumination device with respect to the cover.

7. The apparatus according to claim 6 wherein the self-contained illumination device includes a lens cover through which its illumination passes, and the apparatus includes a fluid cover, adjacent to and receiving that lens cover, through which that illumination also passes, that fluid cover redirecting a portion of that illumination into an illumination array formed about the periphery of the self-contained illumination device.

8. The apparatus according to claim 7 wherein the illumination array is formed by a combination of transparent and translucent surface elements.

9. A cover arrangement for a sewage and sump pump basin, comprising:
a cover, at least a portion of which is formed from material through which the interior of the basin can be visually perceived,
a self-contained illumination device, selectively switchable between illuminating and non-illuminating modes of operation, and operable independently of an external source of power,
an apprastus having:
a first portion for receiving and retaining a self-contained illumination device, and
a second portion for securing the self-contained illumination device to a particular location with respect to the cover and for allowing the self-contained illumination device to provide illumination to the interior of the basin from that location.

10. The cover arrangement according to claim 9 wherein the cover also includes at least one aperture passing through the cover and into the basin, and the apparatus is removably mountable into the aperture.

11. The cover arrangement according to claim 9 wherein the apparatus includes means for illuminating the location of the self-contained illumination device when that device is thereby secured to a particular location with respect to the cover.

12. The cover arrangement according to claim 9 wherein the self-contained illumination devices is removably received and retained by the first portion, and wherein the second portion is removably received and retained by the cover.
